(19) United States
(12) Patent Application Publication
(10) Pub. No.: US 2022/0334878 A1
(43) Pub. Date: Oct. 20, 2022

(54) GENERATING A SHARED VIRTUAL RESOURCE POOL

(71) Applicants: Francesc Guim Bernat, Barcelona (ES); Marcos E. Carranza, Portland, OR (US); Akhilesh Thyagaturu, Tempe, AZ (US)

(72) Inventors: Francesc Guim Bernat, Barcelona (ES); Marcos E. Carranza, Portland, OR (US); Akhilesh Thyagaturu, Tempe, AZ (US)

(21) Appl. No.: 17/854,664

(22) Filed: Jun. 30, 2022

(51) Int. Cl. G06F 9/50

(52) U.S. Cl. CPC G06F 9/505; G06F 9/5061; G06F 9/5038; G06F 2209/5011; G06F 2209/5014

(57) ABSTRACT

System and techniques for generating a virtual shared resource pool are described herein. The system may include means for reserving, by a controller of a first computing device, a resource on a second computing device. Means for instantiating, by the controller of the first computing device, a local service including a virtual function for the resource. The system may also include means for executing a process on the first computing device using the resource from the second computing device via the virtual function.

### TECHNICAL FIELD

Embodiments described herein generally relate to computing devices and more specifically to generating a virtual shared resource pool.

### BACKGROUND

Robots and other autonomous agents may be programmed to complete complex real-world tasks. Robots use artificial intelligence (AI) to perform tasks in industrial environments. Robots span a wide range of industrial applications, such as smart manufacturing assembly lines, multi-robot automotive component assembly, computer and consumer electronics fabrication, smart retail and warehouse logistics, robotic datacenters, etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for generating a shared virtual resource pool, according to an embodiment.

FIG. 2 is a block diagram of an example of an Autonomous Mobile Robot (AMR), according to an embodiment.

FIG. 3 is a block diagram of another example of an AMR, according to an embodiment.

FIG. 4 is a block diagram of another example of an AMR, according to an embodiment.

FIG. 5 illustrates a flow diagram of an example of a method for generating a shared virtual resource pool, according to an embodiment.

FIG. 6 is a block diagram illustrating an example of a machine upon which one or more embodiments may be implemented.

### DETAILED DESCRIPTION

Compute requirements for Autonomous Mobile Robots (AMRs) vary widely depending on the use cases, generations, etc. Currently, some of the constraints that determine a given configuration for a computing system are power consumption or battery life, form factor, or cost. Clearly, selecting a lower speed processor, powering on less memory capacity, etc.—results in consuming lower power which in turn enables longer battery life. Further, fan-less designs may be possible, and smaller chassis may be sufficient—which enables the usage of lighter, more portable form factors. However, there is often a scenario, where worst-case provisioning is required—and the selection of memory configuration, for example, may be done for those times when a user needs to run heavy applications which necessitate large amounts of memory and/or compute or acceleration schemes.

There are two important trends in AMR technology. A first key emerging trend is the improvements in connectivity speeds between these devices. This is a general observation—independent of protocol. For example, with Bluetooth or wireless or even 5G/4G connections, between devices, there has been a massive increase in connectivity speeds. Thus, it is now possible to expect inter-device connectivity speeds that surpass a gigabyte per second.

A second trend is the capability to hot-plug components in computer systems. While in the past, all system components had to be recognized and predetermined at boot time, i.e. a priori, nowadays, we have increasing capability to add to system resources. For example, memory, storage, and compute resources may already be hot-plugged in various degrees. For servers, hot-plug technology may be used with technologies like memory pooling in the DMR timeframe (where we may on-demand map remote memory to the local address map via CXL).

A consequence of the above trends is that the distinction between physical interconnects and buses that connect various device components, and wired or wireless connectivity to the other devices in close proximity starts to blur, and the expectation is that this will continue to blur over the coming decade. Consider, for example, a factory, with multiple AMRs, connected in close proximity. When there is a need for additional resources, be it memory or compute, one may potentially leverage trusted external resources to address local needs, via virtualization at the resource/device level. In other words, we propose an infrastructure to map on additional memory or accelerators or CPUs from remote devices as if they were local, to address peaks in requirements.

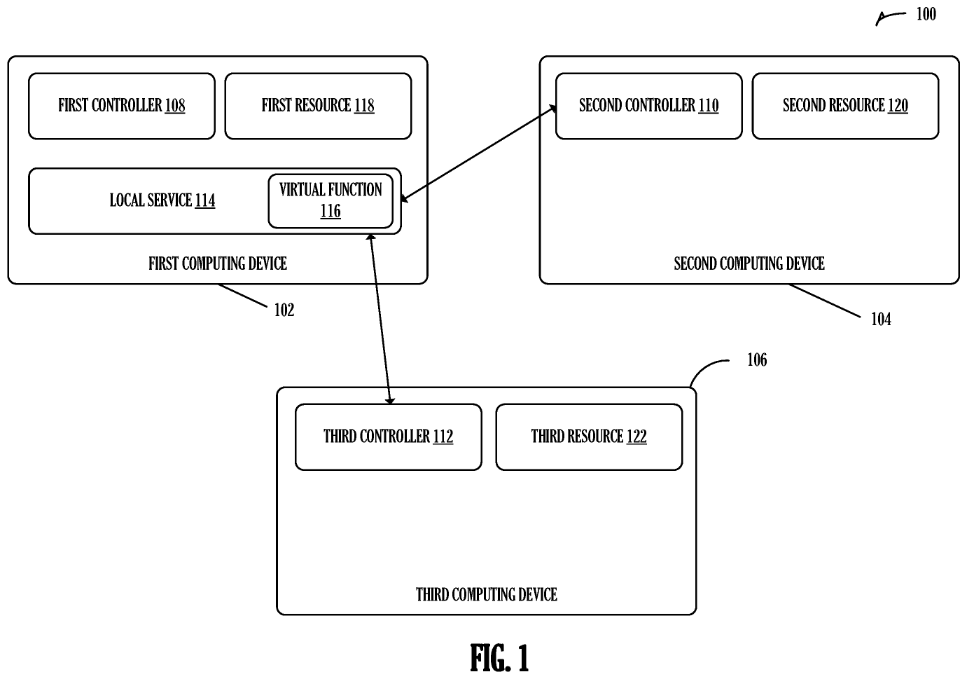

Systems and techniques of the present disclosure provide mechanisms for computing devices (e.g., AMRs) to share different type of resources (e.g., hardware or software) using intelligent processing unit (IPU) as a vehicle for the shared resources. AMRs may share resources by leaveraging Infrastructure Processing Logic (the new term for smart NICs) and CXL technology (new I/O technology). However, the AMR must be expanded to leaverage these two key technologies. The expanded AMRs will be discussed below with reference to FIGS. 1-6.

FIG. 1 is a block diagram of an example of an environment including a system 100. The system 100 is a grouping of computing devices that together complete a method of generating a shared virtual resource pool, according to an embodiment. The system 100 may include a first computing device 102, a second computing device 104, and a third computing device 106 (hereinafter collectively referred to as “computing devices”). The computing devices all may be wirelessly connected to each other. The first computing device 102 may include a first controller 108, a local service 114, and a first resource 118. The local service 114 may include a virtual function 116. The second computing device 104 may include a second controller 110 and a second resource 120. The third computing device 106 may include a third controller 112 and a third resource 122.

In an example, the first controller 108 may reserve the second resource 120 on the second computing device 104. The first controller 108 may then instantiate the local service 114 including the virtual function 116 for the second resource 120 on the second computing device 104. The first computing device 102 may execute a process on the first computing device 102 using the resource 120 from the second computing device 104 via the virtual function 116. In an example, the virtual function 116 may include a software package. The software package on the virtual function 116 may update the software on the first computing device 102 and the second computing device 104. In examples, the software package may be a driver.

In an example, the first controller 108 of the first computing device 102 may also send a first signal indicative of constrained resources. For example, the first controller 108 may broadcast the first signal because the first resource 118 of the first computing device 102 may be constrained. For example, the first computing device 102 may need an increase in computing powers to complete the present tasks of the first computing device 102 such that the first computing device 102 needs help to perform optimally. In response to to the first signal, the first controller 108 may receive a second signal from the second controller 110 of the second computing device 104. The second signal may be indicative of available resources within the second resource 120 of the second computing device 104.

In an example, the first computing device 102 may be an autonomous mobile robot (AMR). In another example, the first computing device 102 and the second computing device 104 may be AMRs. In yet another example, the first computing device 102, the second computing device 104, and the third computing device 106 may be AMRs. When the first computing device 102, the second computing device 104, and the third computing device 106 are in close proximity (e.g., within wireless range of one another) the first computing device 102, the second computing device 104, and the third computing device 106 may communicate and share resources.

In an example, the first controller 108 of the first computing device 102 may be an intelligent processing unit (IPU). In another example, the second controller 110 of the second computing device 104 may also be an IPU. In yet another example, the third controller 112 of the third computing device 106 may also be an IPU. As such, when the first controller 108, the second controller 110, and the third controller 112 are IPUs, the first controller 108, the second controller 110, and the third controller 112 may generate a link between the local service 114 and the controllers of the other devices. For example, when the first controller 108 is an IPU, the first controller 108 may generate a link between the local service 114 and the second controller 110 of the second computing device 104 and the local service 114 and the third controller 112 of the third computing device 106. In an example, the link may be a compute express link (CXL) tunneled over a network protocol. For example, the network protocol may be wireless. The wireless CXL tunnel enables the computing devices to share information (e.g., software) and resources (e.g., hardware) with one another over the local service 114. This is a fast connection that allows the computing devices to leaverage available resources from other computing devices as if they are there own through the virtual function 116 on the local service 114.

In an example, the first resource 118 of the first computing device 102 may be hardware physically located on the first computing device 102. In such an example, the first controller 108 of first computing device 102 may partition the first resource 118 such that other elements of the first computing device 102 do not have access to the first resource 118 after a reservation of the resources on the first computing device 102 is complete.

In another example, the second resource 120 of the second computing device 104 may be hardware physically located on the second computing device 104. In such an example, the second controller 110 of the second computing device 104 may partition the second resource 120 such that other elements of the second computing device 104 do not have access to the second resource 120 after a reservation of the resources on the second computing device 104 is complete.

In yet another example, the third resource 122 of the third computing device 106 may be hardware physically located on the third computing device 106. In such an example, the third controller 112 of the third computing device 106 may partition the third resource 122 such that other elements of the third computing device 106 do not have access to the third resource 122 after a reservation of the resources on the third computing device 106 is complete.

In an example, the first controller 108 of the first computing device 102 may become in close proximity (e.g., within wireless range) to the third computing device 106. In such an example, the third controller 112 of the third computing device 106 may broadcast that the third computing device 106 has a resource pool available. As such, the first controller 108 of the first computing device 102 may request to join the available resource pool on the third computing device 106. The first computing device 102 may then receive an attestation from the third controller 112 of the third computing device 106 for the identities of computing devices connected to the available resource pool. In response to the receipt of attestation for the identities of the computing devices connected to the available resource pool, the first controller 108 of the first computing device 102 may join the available resource pool. In another example, the first controller 108 may revoke the request to join the available resource pool in response to not receiving attestation from the third computing device 106 of the identities of the computing devices connected to the available resource pool.

In an example, the first controller 108 may broadcast a request for computing devices capable of creating a resource pool. The first controller 108 may authenticate computing devices that respond to the request with an indication that the resource pool can be created. In response to authenticating the computing devices, the first controller 108 may create a new resource pool. After the new resource pool is created, the first controller 108 may broadcast an alert signal that includes an identification of the new virtual pool. The alert signal may notify other computing devices (e.g., servers or AMRs) of the availability of the new resource pool.

In an example, the first computing device 102 may be a server installed in a large-capacity building, and the second computing device 104 may be an AMR located proximate the large-capacity building. The second computing device 104 may be positioned proximate the large-capacity building to help the server accommodate a surge in capacity within the large-capacity building. In an example, the large-capacity building may be a sports stadium, and proximate to the sports stadium may be within wireless range of the server. In examples, a network of computing devices (e.g., the first computing device 102) may be connected to supply a service (e.g., cellular service) within the sports stadium. To aid in computing capacity when the sports stadium is near capacity, the AMRs may be positioned around the periphery of the sports stadiums near the the network of computing devices. As such, the examples discussed above may be implemented to help provide resources (e.g., software or hardware) to the network of computing devices within the sports stadium to increase the computing capabilities within the sports stadium and improve the cellular service for people within the sports stadium.

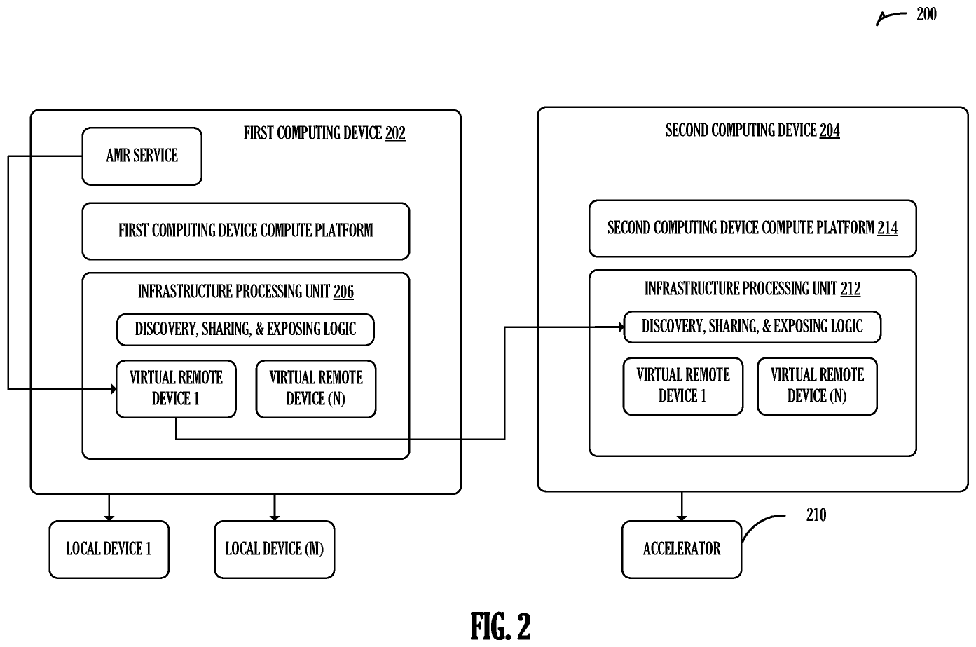

FIG. 2 is a block diagram of an example of a system 200 including a first computing device 202 and a second computing device 204. In examples, the first computing device 202 and the second computing device 204 may be Autonomous Mobile Robots (AMRs). The following discussion provided a framework for AMRs to enable pooling therebetween. Using the intelligent processing unit (IPU) and compute express link (CXL) as baseline (expanding the IPU architecture) we expand the AMRs in order to broadcast to peers resources that the AMRs are not using or may not use in the future. The broadcast may include what type of resource it is, for long it won't be used, compute capacity or any other information about the availability of the resources of the AMRs. In the example shown in FIG. 2, the second computing device 204 is not using an Accelerator 210 device. The architecture of the computing devices may also enable the computing devices to discover available resources located on the other computing devices and virtually expose the computing devices to the local services running in the computing device (e.g., the first computing device 202 or the second computing device 204, or any other computing device connected to the local service). CXL over the air tunneling may be used as the standard mechanism to expose the computing devices to other computing devices via virtual functions.

In an example, the architecture of the computing devices may require the connection of the remote resource of a second computing device (e.g., the second computing device 204) to the local service of the first computing device (e.g., the first computing device 202) map it to the local service. In the example, after a software stack, (e.g., virtual functions) of the first computing device 202 discovers that the second computing device 204 is not using the accelerator 210, the first computing device 202 may request access to the accelerator 210 of the second computing device 204 via an infrastructure processing unit 212 of the second computing device 204. An infrastructure processing unit 206 on the first computing device 202 and the infrastructure processing unit 212 on the second computing device 204 work together to enable the sharing of the accelerator 210 from the second computing device 204 to the first computing device 202. In preparation of the first computing device 202 using the accelerator 210 of the second computing device 204, the second computing device 204 may partition (or disconnect) the accelerator 210 from a local platform 214 of the second computing device 204. After the accelerator 210 is disconnected from the local platform 214 of the second computing device 204, the second computing device 204 may share the accelerator 210 with the first computing device 202 to the local service via the virtual functions. The local service may use the accelerator 210 using virtual functions as it would be a local resource.

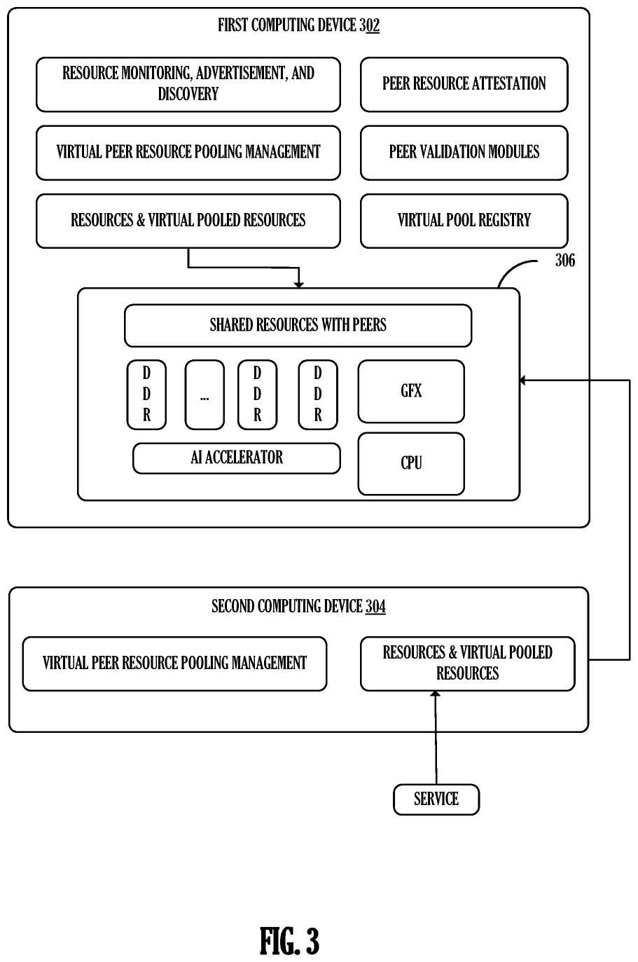

FIG. 3 is a block diagram of another example of a first AMR (e.g., A first computing device 302) and a second AMR (e.g., a second computing device 304), according to an embodiment. The following high-level elements are included in the architecture of the each of the AMRs in a network of AMRs. Multiple devices may be mapped into a virtual resource pool of resources 306 that is associated with a particular tenant/user or virtual organization. Each of these connected devices (e.g., the first computing device 302 and the second computing device 304), as some of their resources become not utilized, may advertise them into the pools of resources 306. Devices may have certain capabilities (e.g. media or AI acceleration, compute power, etc.). Each of these devices, as they require more compute horsepower (e.g. power needed to perform a certain type of analytics) or require a specialized type of hardware (e.g. biometric accelerated authentication) may access the pool to discover if there is any availability of the resources they are scarce. Here, bandwidth and latency between two devices (e.g., the first computing device 302 and the second computing device 304) may be a factor to decide which device/resource to request access to. When there is a matching of offer versus demand of a particular resource, the resource owner may allocate the available resource to the remote device, the remote device may expose the available resource as a virtual resource to the application running in the remote device (e.g. one extra vCPU or vGFX) and the application may use the available resource for a certain amount of time. The above-described architecture requires authentication, attestation, and hand-shaking protocols, which are discussed in more detail below.

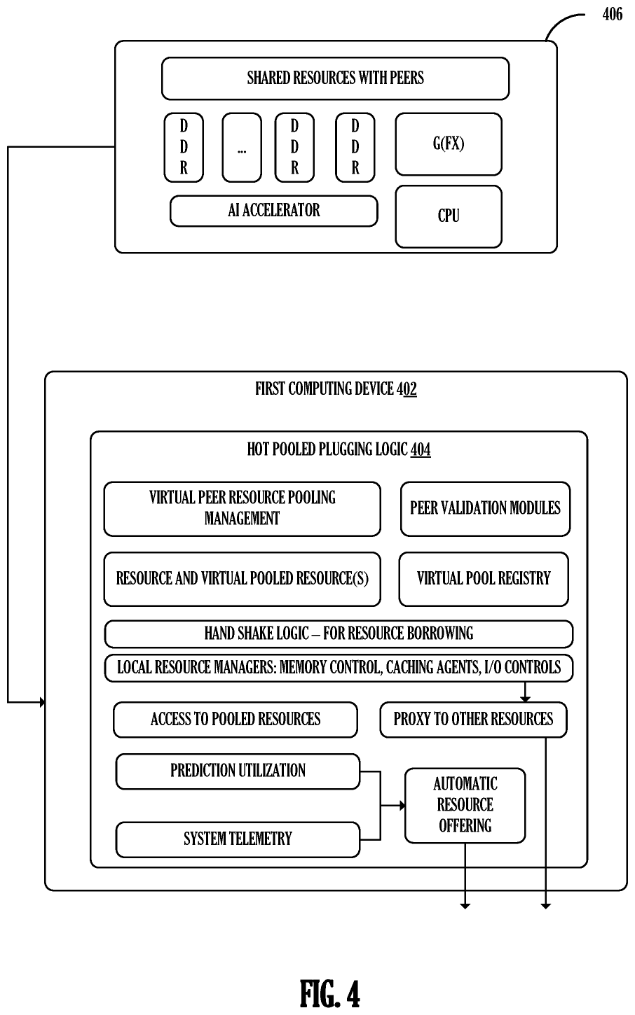

FIG. 4 is a block diagram of another example of an AMR (e.g., a first computing device 402), according to an embodiment. In order to implement the trusted resource pooling and hot plugging described earlier in the document, the architecture of the first computing device 402 may be expanded to include means to create the aforementioned virtual pools in a trustworthy way, means to expose and access to resources to those memory pools, and means to allow devices to request access to those shared resources and expose them as new virtual or physical resource to the software stack running in the local device.

The first computing device 402 shown in FIG. 4, may include a new logic called hot pooled plugging logic (hereinafter logic 404) that is responsible to implement the new apparatus. The hereinafter logic 404 may include the following elements. The hot-pooled plugging logic may be responsible to discover, register and validate a particular AMR resource pool. Note that resource pools may be created in a peer-to-peer fashion (there is no central placement to store the data that defines a pool). The logic 404 may constantly monitor the various transport layers mapped into the pooling (e.g. wifi etc.) to see if there are any devices that have created a resource pool or if there are any devices that potentially can create a resource pool. If the logic 404 identifies a virtual pool of resources 406 mapped into the tenant or virtual organization: the logic 404 may request to join the virtual pool. The logic 404 may attest to the identity of all the devices participating in the pool. The logic 404 of the peers may attest to the identity of the device and grant access to the pool on authentication. When the grant is happening, the device (e.g., the first computing device 402 or any other AMR connecting to the system) may get a copy of the latest advertised devices by one of the peers.

If the logic 404 does not identify a pool of resources but identifies one device that belongs to its tenant or virtual organization the logic 404 may request to create a virtual pool. The logic device may authenticate the other device. The logic (e.g., the logic 404) of the peer may attest to the identity of the device before creating the pool on authentication. A new virtual pool with a virtual ID may be created between the two devices. Each of the two devices may broadcast periodically the existence of this pool. The logic 404 may use prediction based on historic data in order to proactively request the generation of a resource pool (e.g., for a periodic nightly job running every night from for a predetermined set time).

The new virtual pool may include a logic (e.g., a software package or a learning algorithm) responsible to manage the local resources and mapped or unmap them for the resource pool. The logic may use telemetry from each of the resources to identify when a resource is not being fully utilized and part of it may be registered to the pool. The logic may use prediction or fingerprinting techniques to predict that a specific resource won't be used for a certain period of time. When resources are identified to be potentially shared they will broadcast to the peers belonging to the virtual pool. The resource and information about that resource (e.g., meta-data of that resource (e.g. acceleration, power, etc.) or duration of time that is expected to be available) may be included in the broadcast. When resource demand for a particular resource of the pool being utilized by another peer increases, the logic may reach out to the peer to ask back the resources or provide notice that the resource may be needed in the coming future. In examples, the virtual pool may be exposed by creating virtual or physical peripheral component interconnect express (PCIE) functions to the local AMR (the first computing device 402) functions (e.g., virtual functions).

When demand for a particular resource on the pool not used by any peer is requested, the logic (e.g., the logic 404) may broadcast to the peers in the pool to remove that particular resource from the pool. The broadcast may include a logic that is responsible to manage access to the resources that are being shared with the other peers. For example, once the logic 404 identifies that a particular application requires or would benefit from an extra resource (e.g. memory, CPU or GFX acceleration), it may look at the pool to see if these resources are advertised by one or more peers. If the positive case, the logic 404 may select one of those peers, selection may be based on the type of resource (e.g. newer versus older generation) available, the bandwidth and latency between the two devices, and the performance needed for the offload compute.

When a controller connects with the resource, the resource may be removed from the pool of resources, which will require a broadcast to all peers of the virtual pool. The logic 404 may also create a handshake protocol with the devices sharing the resources. Once the handshake is completed, the logic 404 may expose the remote device as a local device, either exposing it as a virtual or physical device. A software stack for the logic 404 may be transferred to the connected devices. The software stack may be re-routed to the peer devices but it will look as if it would be local.

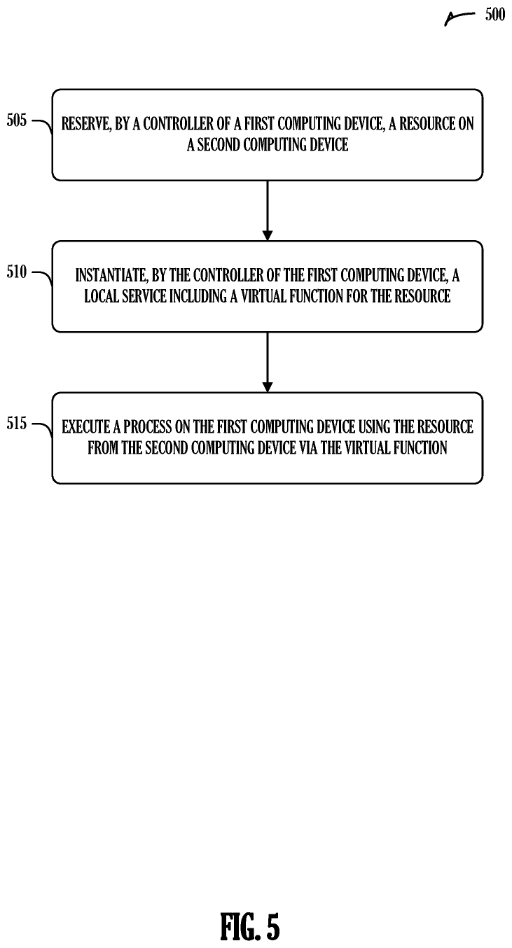

FIG. 5 illustrates a flow diagram of an example of a method 500 for generating a shared virtual resource pool, according to an embodiment. T

[symbol]

At operation 505, the method 500 may include a controller of a first computing device reserving a resource on a second computing device. For example, the first computing device may require additional hardware or software capabilities to complete tasks. The controller of the first computing device may broadcast a need for the resource, and the controller of the second computing device may broadcast the availability of the resource. As such, the first controller may reserve the unneeded resource on the second computing device.

At operation 510, the controller of the first computing device may instantiate a local service including a virtual function for the resource. The local service may be used by the first computing device to use the resource of the second computing device.

At operation 515, the first computing device may execute a process using the resource from the second computing device via the virtual function. The virtual function may make it so that the first computing device communicates with the resources on the second computing device just as if the resources were on the first computing device. In examples, the resources may be extended from various levels, for example, internal to an AMR, from one AMR to another AMR, or from an AMR to an edge node.

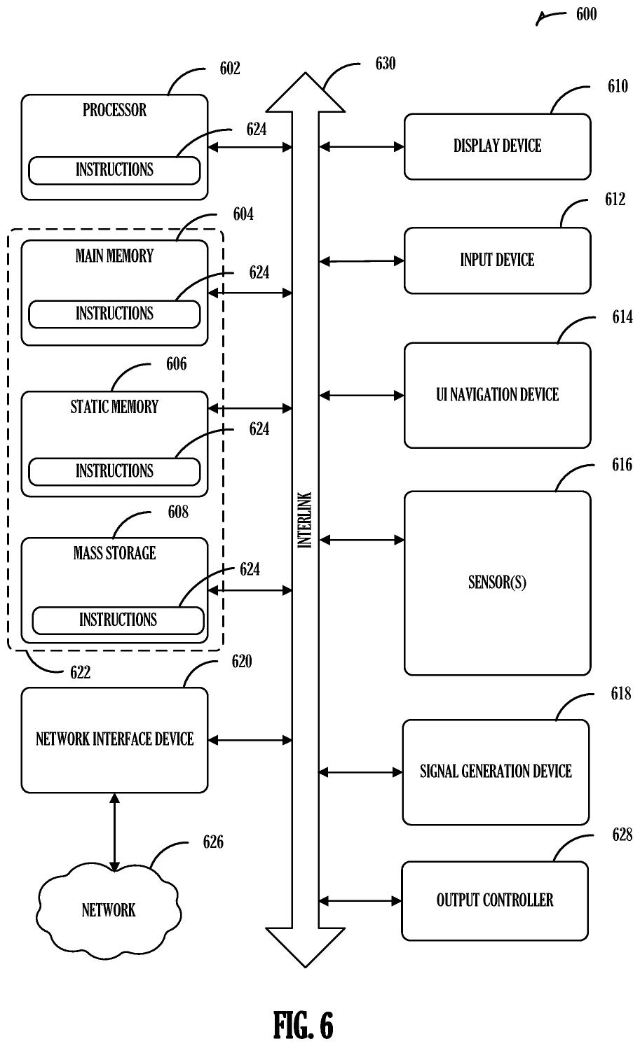

FIG. 6 illustrates a block diagram of an example machine 600 upon which any one or more of the techniques (e.g., methodologies) discussed herein may perform. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drives, tape drives, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 622 may be representative of the instructions 624, such as instructions 624 themselves or a format from which the instructions 624 may be derived. This format from which the instructions 624 may be derived may include source code, encoded instructions (e.g., in compressed or encrypted form), packaged instructions (e.g., split into multiple packages), or the like. The information representative of the instructions 624 in the machine readable medium 622 may be processed by processing circuitry into the instructions to implement any of the operations discussed herein. For example, deriving the instructions 624 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 may include assembly, compilation, or interpretation of the information (e.g., by the processing circuitry) to create the instructions 624 from some intermediate or preprocessed format provided by the machine readable medium 622. The information, when provided in multiple parts, may be combined, unpacked, and modified to create the instructions 624. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

### Additional Notes & Examples

Example 1 is a method for generating a shared virtual resource pool, the method comprising: reserving, by a controller of a first computing device, a resource on a second computing device; instantiating, by the controller of the first computing device, a local service including a virtual function for the resource; and executing a process on the first computing device using the resource from the second computing device via the virtual function.

In Example 2, the subject matter of Example 1 includes, wherein the resource is partitioned by the second computing device such that other elements of the second computing device do not have access to the resource after a reservation of the resources on the second computing device is complete.

In Example 3, the subject matter of Example 2 includes, broadcasting, with the controller of the first computing device, a first signal indicative of constrained resources; and receiving, from a controller of the second computing device, a second signal indicative of available resources.

In Example 4, the subject matter of Examples 1-3 includes, wherein the first computing device is an autonomous mobile robot (AMR).

In Example 5, the subject matter of Example 4 includes, wherein the controller of the first computing device is implemented in an intelligent processing unit (IPU), the IPU generates a link between the local service and the controller of the second computing device.

In Example 6, the subject matter of Example 5 includes, wherein the link is a compute express link (CXL) tunneled over a network protocol.

In Example 7, the subject matter of Example 6 includes, instantiating peripheral component interconnect express (PCIE) virtual functions, the PCIE virtual functions enable the first computing device to use the resource of the second computing device as local.

In Example 8, the subject matter of Example 7 includes, wherein the PCIE virtual functions use CXL memory or CXL cache to expose remote resources.

In Example 9, the subject matter of Examples 6-8 includes, wherein the network protocol operates over a wireless physical layer.

In Example 10, the subject matter of Examples 1-9 includes, requesting to join an available resource pool on a third computing device; receiving attestation from the third computing device for identities of computing devices connected to the available resource pool; and joining, in response to receipt of attestation for the identities of the computing devices, the available resource pool.

In Example 11, the subject matter of Examples 1-10 includes, transmitting a request to join an available resource pool on a third computing device; and revoking, in response to failing to receive attestation from the third computing device for identities of computing devices connected to the available resource pool, the request to join the available resource pool.

In Example 12, the subject matter of Examples 9-11 includes, broadcasting, by the controller of the first computing device, a request for computing devices capable of creating a resource pool; authenticating computing devices that respond to the request with an indication that the resource pool can be created; creating, in response to authenticating a computing device, a new resource pool; and broadcasting an alert signal that includes identification of the new resource pool to notify other computing devices of the availability of the new resource pool.

In Example 13, the subject matter of Examples 1-12 includes, wherein the resource of the second computing device is hardware physically located on the second computing device.

In Example 14, the subject matter of Examples 1-13 includes, wherein the virtual function includes a software package, the software package configured to modify software on the first and second computing devices, and wherein the software package is a driver.

In Example 15, the subject matter of Examples 1-14 includes, wherein the first computing device is a server installed in a large-capacity building, and the second computing device is an autonomous mobile robot (AMR) located proximate to the large-capacity building to help the server accommodate a surge in capacity within the large-capacity building.

In Example 16, the subject matter of Example 15 includes, wherein the large-capacity building is a sports stadium, and wherein proximate to the sports stadium is within wireless range of the server.

Example 17 is at least one machine readable medium including instructions that, when executed by processing circuitry, cause the processing circuitry to perform any method of Examples 1-16.

Example 18 is a system comprising means to perform any method of Examples 1-16.

Example 19 is a device for generating a shared virtual resource pool, the device comprising: a memory including instructions; and processing circuitry that, when in operation, is configured by the instructions to: reserve, with processing circuitry of a controller of a first computing device, a resource on a second computing device; instantiate, with processing circuitry of the controller of the first computing device, a local service including a virtual function for the resource; and execute a process on the first computing device using the resource from the second computing device via the virtual function.

In Example 20, the subject matter of Example 19 includes, wherein the resource is partitioned by the second computing device such that other elements of the second computing device do not have access to the resource after a reservation of the resources on the second computing device is complete.

In Example 21, the subject matter of Example 20 includes, wherein the instructions configured the processing circuitry to: broadcast, with the controller of the first computing device, a first signal indicative of constrained resources; and receive, from a controller of the second computing device, a second signal indicative of available resources.

In Example 22, the subject matter of Examples 19-21 includes, wherein the first computing device is an autonomous mobile robot (AMR).

In Example 23, the subject matter of Example 22 includes, wherein the controller of the first computing device is implemented in an intelligent processing unit (IPU), the IPU generates a link between the local service and the controller of the second computing device.

In Example 24, the subject matter of Example 23 includes, wherein the link is a compute express link (CXL) tunneled over a network protocol.

In Example 25, the subject matter of Example 24 includes, wherein the instructions configured the processing circuitry to: instantiate peripheral component interconnect express (PCIE) virtual functions, the PCIE virtual functions enable the first computing device to use the resource of the second computing device as local.

In Example 26, the subject matter of Example 25 includes, wherein the PCIE virtual functions use CXL memory or CXL cache to expose remote resources.

In Example 27, the subject matter of Examples 24-26 includes, wherein the network protocol operates over a wireless physical layer.

In Example 28, the subject matter of Examples 19-27 includes, wherein the instructions configured the processing circuitry to: request to join an available resource pool on a third computing device; receive attestation from the third computing device for identities of computing devices connected to the available resource pool; and join, in response to receipt of attestation for the identities of the computing devices, the available resource pool.

In Example 29, the subject matter of Examples 19-28 includes, wherein the instructions configured the processing circuitry to: transmit a request to join an available resource pool on a third computing device; and revoking, in response to failing to receive attestation from the third computing device for identities of computing devices connected to the available resource pool, the request to join the available resource pool.

In Example 30, the subject matter of Examples 27-29 includes, wherein the instructions configured the processing circuitry to: broadcast, by processing circuitry of the controller of the first computing device, a request for computing devices capable of creating a resource pool; authenticate computing devices that respond to the request with an indication that the resource pool can be created; create, in response to authenticating a computing device, a new resource pool; and broadcast an alert signal that includes identification of the new resource pool to notify other computing devices of the availability of the new resource pool.

In Example 31, the subject matter of Examples 19-30 includes, wherein the resource of the second computing device is hardware physically located on the second computing device.

In Example 32, the subject matter of Examples 19-31 includes, wherein the virtual function includes a software package, the software package configured to modify software on the first and second computing devices, and wherein the software package is a driver.

In Example 33, the subject matter of Examples 19-32 includes, wherein the first computing device is a server installed in a large-capacity building, and the second computing device is an autonomous mobile robot (AMR) located proximate to the large-capacity building to help the server accommodate a surge in capacity within the large-capacity building.

In Example 34, the subject matter of Example 33 includes, wherein the large-capacity building is a sports stadium, and wherein proximate to the sports stadium is within wireless range of the server.

Example 35 is at least one machine readable medium including instructions for generating a shared virtual resource pool, the instructions, when executed by processing circuitry, cause the processing circuitry to perform operations comprising: reserving, by a controller of a first computing device, a resource on a second computing device; instantiating, by the controller of the first computing device, a local service including a virtual function for the resource; and executing a process on the first computing device using the resource from the second computing device via the virtual function.

In Example 36, the subject matter of Example 35 includes, wherein the resource is partitioned by the second computing device such that other elements of the second computing device do not have access to the resource after a reservation of the resources on the second computing device is complete.

In Example 37, the subject matter of Example 36 includes, wherein the operations comprise: broadcasting, with the controller of the first computing device, a first signal indicative of constrained resources; and receiving, from a controller of the second computing device, a second signal indicative of available resources.

In Example 38, the subject matter of Examples 35-37 includes, wherein the first computing device is an autonomous mobile robot (AMR).

In Example 39, the subject matter of Example 38 includes, wherein the controller of the first computing device is implemented in an intelligent processing unit (IPU), the IPU generates a link between the local service and the controller of the second computing device.

In Example 40, the subject matter of Example 39 includes, wherein the link is a compute express link (CXL) tunneled over a network protocol.

In Example 41, the subject matter of Example 40 includes, wherein the operations comprise: instantiating peripheral component interconnect express (PCIE) virtual functions, the PCIE virtual functions enable the first computing device to use the resource of the second computing device as local.

In Example 42, the subject matter of Example 41 includes, wherein the PCIE virtual functions use CXL memory or CXL cache to expose remote resources.

In Example 43, the subject matter of Examples 40-42 includes, wherein the network protocol operates over a wireless physical layer.

In Example 44, the subject matter of Examples 35-43 includes, wherein the operations comprise: requesting to join an available resource pool on a third computing device; receiving attestation from the third computing device for identities of computing devices connected to the available resource pool; and joining, in response to receipt of attestation for the identities of the computing devices, the available resource pool.

In Example 45, the subject matter of Examples 35-44 includes, wherein the operations comprise: transmitting a request to join an available resource pool on a third computing device; and revoking, in response to failing to receive attestation from the third computing device for identities of computing devices connected to the available resource pool, the request to join the available resource pool.

In Example 46, the subject matter of Examples 43-45 includes, wherein the operations comprise: broadcasting, by the controller of the first computing device, a request for computing devices capable of creating a resource pool; authenticating computing devices that respond to the request with an indication that the resource pool can be created; creating, in response to authenticating a computing device, a new resource pool; and broadcasting an alert signal that includes identification of the new resource pool to notify other computing devices of the availability of the new resource pool.

In Example 47, the subject matter of Examples 35-46 includes, wherein the resource of the second computing device is hardware physically located on the second computing device.

In Example 48, the subject matter of Examples 35-47 includes, wherein the virtual function includes a software package, the software package configured to modify software on the first and second computing devices, and wherein the software package is a driver.

In Example 49, the subject matter of Examples 35-48 includes, wherein the first computing device is a server installed in a large-capacity building, and the second computing device is an autonomous mobile robot (AMR) located proximate to the large-capacity building to help the server accommodate a surge in capacity within the large-capacity building.

In Example 50, the subject matter of Example 49 includes, wherein the large-capacity building is a sports stadium, and wherein proximate to the sports stadium is within wireless range of the server.

Example 51 is a system for generating a shared virtual resource pool, the system comprising: means for reserving, by a controller of a first computing device, a resource on a second computing device; means for instantiating, by the controller of the first computing device, a local service including a virtual function for the resource; and means for executing a process on the first computing device using the resource from the second computing device via the virtual function.

In Example 52, the subject matter of Example 51 includes, wherein the resource is partitioned by the second computing device such that other elements of the second computing device do not have access to the resource after a reservation of the resources on the second computing device is complete.

In Example 53, the subject matter of Example 52 includes, means for broadcasting, with the controller of the first computing device, a first signal indicative of constrained resources; and means for receiving, from a controller of the second computing device, a second signal indicative of available resources.

In Example 54, the subject matter of Examples 51-53 includes, wherein the first computing device is an autonomous mobile robot (AMR).

In Example 55, the subject matter of Example 54 includes, wherein the controller of the first computing device is implemented in an intelligent processing unit (IPU), the IPU generates a link between the local service and the controller of the second computing device.

In Example 56, the subject matter of Example 55 includes, wherein the link is a compute express link (CXL) tunneled over a network protocol.

In Example 57, the subject matter of Example 56 includes, means for instantiating peripheral component interconnect express (PCIE) virtual functions, the PCIE virtual functions enable the first computing device to use the resource of the second computing device as local.

In Example 58, the subject matter of Example 57 includes, wherein the PCIE virtual functions use CXL memory or CXL cache to expose remote resources.

In Example 59, the subject matter of Examples 56-58 includes, wherein the network protocol operates over a wireless physical layer.

In Example 60, the subject matter of Examples 51-59 includes, means for requesting to join an available resource pool on a third computing device; means for receiving attestation from the third computing device for identities of computing devices connected to the available resource pool; and means for joining, in response to receipt of attestation for the identities of the computing devices, the available resource pool.

In Example 61, the subject matter of Examples 51-60 includes, means for transmitting a request to join an available resource pool on a third computing device; and means for revoking, in response to failing to receive attestation from the third computing device for identities of computing devices connected to the available resource pool, the request to join the available resource pool.

In Example 62, the subject matter of Examples 59-61 includes, means for broadcasting, by the controller of the first computing device, a request for computing devices capable of creating a resource pool; means for authenticating computing devices that respond to the request with an indication that the resource pool can be created; means for creating, in response to authenticating a computing device, a new resource pool; and means for broadcasting an alert signal that includes identification of the new resource pool to notify other computing devices of the availability of the new resource pool.

In Example 63, the subject matter of Examples 51-62 includes, wherein the resource of the second computing device is hardware physically located on the second computing device.

In Example 64, the subject matter of Examples 51-63 includes, wherein the virtual function includes a software package, the software package configured to modify software on the first and second computing devices, and wherein the software package is a driver.

In Example 65, the subject matter of Examples 51-64 includes, wherein the first computing device is a server installed in a large-capacity building, and the second computing device is an autonomous mobile robot (AMR) located proximate to the large-capacity building to help the server accommodate a surge in capacity within the large-capacity building.

In Example 66, the subject matter of Example 65 includes, wherein the large-capacity building is a sports stadium, and wherein proximate to the sports stadium is within wireless range of the server.

Example 67 is at least one machine-readable medium including instructions that, when executed by processing circuitry, cause the processing circuitry to perform operations to implement of any of Examples 1-66.

Example 68 is an apparatus comprising means to implement of any of Examples 1-66.

Example 69 is a system to implement of any of Examples 1-66.

Example 70 is a method to implement of any of Examples 1-66.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device for generating a shared virtual resource pool, the device comprising:
a memory including instructions; and
processing circuitry that, when in operation, is configured by the instructions to:
reserve, with processing circuitry of a controller of a first computing device, a resource on a second computing device;
instantiate, with processing circuitry of the controller of the first computing device, a local service including a virtual function for the resource; and
execute a process on the first computing device using the resource from the second computing device via the virtual function.

2. The device of claim 1, wherein the resource is partitioned by the second computing device such that other elements of the second computing device do not have access to the resource after a reservation of the resources on the second computing device is complete.

3. The device of claim 1, wherein the controller of the first computing device is implemented in an intelligent processing unit (IPU), the IPU generates a link between the local service and the controller of the second computing device.

4. The device of claim 1, wherein the instructions configured the processing circuitry to:
request to join an available resource pool on a third computing device;
receive attestation from the third computing device for identities of computing devices connected to the available resource pool; and
join, in response to receipt of attestation for the identities of the computing devices, the available resource pool.

5. The device of claim 1, wherein the instructions configured the processing circuitry to:
transmit a request to join an available resource pool on a third computing device; and
revoking, in response to failing to receive attestation from the third computing device for identities of computing devices connected to the available resource pool, the request to join the available resource pool.

6. The device of claim 1, wherein the instructions configured the processing circuitry to:
broadcast, by processing circuitry of the controller of the first computing device, a request for computing devices capable of creating a resource pool;
authenticate computing devices that respond to the request with an indication that the resource pool can be created;
create, in response to authenticating a computing device, a new resource pool; and
broadcast an alert signal that includes identification of the new resource pool to notify other computing devices of the availability of the new resource pool.

7. The device of claim 1, wherein the first computing device is a server installed in a large-capacity building, and the second computing device is an autonomous mobile robot (AMR) located proximate to the large-capacity building to help the server accommodate a surge in capacity within the large-capacity building.

8. The device of claim 7, wherein the large-capacity building is a sports stadium, and wherein proximate to the sports stadium is within wireless range of the server.

9. At least one non-transient machine readable medium including instructions for generating a shared virtual resource pool, the instructions, when executed by processing circuitry, cause the processing circuitry to perform operations comprising:
reserving, by a controller of a first computing device, a resource on a second computing device;
instantiating, by the controller of the first computing device, a local service including a virtual function for the resource; and
executing a process on the first computing device using the resource from the second computing device via the virtual function.

10. The at least one non-transient machine readable medium of claim 9, wherein the resource is partitioned by the second computing device such that other elements of the second computing device do not have access to the resource after a reservation of the resources on the second computing device is complete.

11. The at least one non-transient machine readable medium of claim 9, wherein the controller of the first computing device is implemented in an intelligent processing unit (IPU), the IPU generates a link between the local service and the controller of the second computing device.

12. The at least one non-transient machine readable medium of claim 9, wherein the operations comprise:
requesting to join an available resource pool on a third computing device;
receiving attestation from the third computing device for identities of computing devices connected to the available resource pool; and
joining, in response to receipt of attestation for the identities of the computing devices, the available resource pool.

13. The at least one non-transient machine readable medium of claim 9, wherein the operations comprise:
transmitting a request to join an available resource pool on a third computing device; and
revoking, in response to failing to receive attestation from the third computing device for identities of computing devices connected to the available resource pool, the request to join the available resource pool.

14. The at least one non-transient machine readable medium of claim 9, wherein the operations comprise:
broadcasting, by the controller of the first computing device, a request for computing devices capable of creating a resource pool;
authenticating computing devices that respond to the request with an indication that the resource pool can be created;
creating, in response to authenticating a computing device, a new resource pool; and
broadcasting an alert signal that includes identification of the new resource pool to notify other computing devices of the availability of the new resource pool.

15. The at least one non-transient machine readable medium of claim 9, wherein the first computing device is a server installed in a large-capacity building, and the second computing device is an autonomous mobile robot (AMR) located proximate to the large-capacity building to help the server accommodate a surge in capacity within the large-capacity building.

16. The at least one non-transient machine readable medium of claim 15, wherein the large-capacity building is a sports stadium, and wherein proximate to the sports stadium is within wireless range of the server.

17. A system for generating a shared virtual resource pool, the system comprising:
means for reserving, by a controller of a first computing device, a resource on a second computing device;
means for instantiating, by the controller of the first computing device, a local service including a virtual function for the resource; and
means for executing a process on the first computing device using the resource from the second computing device via the virtual function.

18. The system of claim 17, wherein the resource is partitioned by the second computing device such that other elements of the second computing device do not have access to the resource after a reservation of the resources on the second computing device is complete.

19. The system of claim 17, wherein the controller of the first computing device is implemented in an intelligent processing unit (IPU), the IPU generates a link between the local service and the controller of the second computing device.

20. The system of claim 17, comprising:
means for requesting to join an available resource pool on a third computing device;
means for receiving attestation from the third computing device for identities of computing devices connected to the available resource pool; and
means for joining, in response to receipt of attestation for the identities of the computing devices, the available resource pool.

21. The system of claim 17, comprising:
means for transmitting a request to join an available resource pool on a third computing device; and
means for revoking, in response to failing to receive attestation from the third computing device for identities of computing devices connected to the available resource pool, the request to join the available resource pool.

22. The system of claim 17, comprising:
means for broadcasting, by the controller of the first computing device, a request for computing devices capable of creating a resource pool;
means for authenticating computing devices that respond to the request with an indication that the resource pool can be created;
means for creating, in response to authenticating a computing device, a new resource pool; and
means for broadcasting an alert signal that includes identification of the new resource pool to notify other computing devices of the availability of the new resource pool.

23. The system of claim 17, wherein the first computing device is a server installed in a large-capacity building, and the second computing device is an autonomous mobile robot (AMR) located proximate to the large-capacity building to help the server accommodate a surge in capacity within the large-capacity building.

24. The system of claim 23, wherein the large-capacity building is a sports stadium, and wherein proximate to the sports stadium is within wireless range of the server.
